(19) United States
(12) Patent Application Publication
(10) Pub. No.: US 2008/0027740 A1
(43) Pub. Date: Jan. 31, 2008

(54) Price stabilization for extended services coverage

(76) Inventors: Jeffrey Lynn Pridgen, Brentwood, TN (US); Cynthia Chilcoat-Dowdy, Brentwood, TN (US)

Correspondence Address: CATERPILLAR/FINNEGAN, HENDERSON, L.L.P., 901 New York Avenue, NW, WASHINGTON, DC, 20001-4413, US

(21) Appl. No.: 11/495,656

(22) Filed: Jul. 31, 2006

(51) Int. Cl. G06Q 99/00

(52) U.S. Cl. 705/1

(57) ABSTRACT

A system is disclosed that provides price stabilization for extended services coverage of a product. The system has a memory and a processor. The processor is configured to determine a first value associated with an extended services coverage of a first product. The processor is also configured to determine a set of second values associated with the first product, the set of second values reflecting values associated with the extended services coverage, and determine a third value based on the first value and the set of second values. The processor is further configured to determine a final value for the extended services coverage of the first product based on the first value and the third value, and provide the final value to an entity. The final value is for use in a transaction package involving the extended services coverage for the first product.

### TECHNICAL FIELD

The present disclosure relates generally to extended services coverage, and more particularly, to systems and methods for stabilizing prices associated with extended services coverage.

### BACKGROUND

Businesses often offer extended services coverage for their products to provide a measure of assurance as to the quality and/or the effective cost of ownership of the products. The effective cost of a product includes the costs associated with the purchase, maintenance, and servicing of a product over the product's life. By spending a predetermined dollar amount to purchase extended services coverage, customers have a defined measure of the cost of ownership because the extended services coverage is designed to offset unexpected costs associated with a product, such as repair, parts replacement, labor, and the like. Extended services coverage may typically be in the form of an insurance, warranty, guarantee, indemnity, and other similar agreements.

Over the life of a product, the price of extended services coverage may vary. This is because the information used to generate the cost of extended services coverage can change over the life of a product due to re-engineering of the product, parts changes associated with the product, analysis of failure trends, and the like. This fluctuation in the price of extended services coverage results in a fluctuation in the effective cost of ownership of a product.

Methods have been created to analyze the economic effect of product warranty associated with a product and to determine an effective cost of a product using a statistical model of the failure rate of the product. One such example is U.S. Patent Publication No. 2003/0033170 (the '170 publication) to Bhatt et al. and published on Feb. 13, 2003. The '170 publication discloses a system and method for utilizing the failure data of a product, in addition to the economic data associated with the product and its warranty, to determine an effective cost of a product and an effective selling price for a replacement product of a failed product. In the '170 publication, the effective cost, effective selling price data, and variation in profit margin are determined for a range of warranty durations and warranty types for the product.

Although the system and method of the '170 publication may enable a warrantor to analyze the economic impact, e.g., profit margin, of any warranty proposed by a customer during negotiations, the system and method do not offer a way to reduce fluctuation in the price of extended services coverage. Thus, the system of the '170 publication does not offer a way to stabilize the price of extended services coverage.

The disclosed system is directed to overcoming one or more of the problems set forth above.

### SUMMARY OF THE INVENTION

In one aspect, the present disclosure is directed to a system for providing price stabilization for extended services coverage of a product. The system includes a memory and a processor. The processor is configured to determine a first value associated with an extended services coverage of a first product. The processor is also configured to determine a set of second values associated with the first product, the set of second values reflecting values associated with the extended services coverage, and determine a third value based on the first value and the set of second values. The processor is further configured to determine a final value for the extended services coverage of the first product based on the first value and the third value, and providing the final value to an entity. The final value is for use in a transaction package involving the extended services coverage for the first product.

In another aspect, the present disclosure is directed to a method for providing price stabilization for extended services coverage of a product. The method includes determining a first value associated with an extended services coverage of a first product. The method also includes determining a set of second values associated with the first product, the set of second values reflecting values associated with the extended services coverage, and determining a third value based on the first value and the set of second values to determine whether the first value is within a range defined by the set of second values. The method further includes determining a final value for the extended services coverage of the first product based on the first value and the third value, and providing the final value to an entity. The final value is for use in a transaction package involving the extended services coverage for the first product.

### BRIEF DESCRIPTION OF THE DRAWINGS

FIG. 1 is a block diagram of an exemplary system consistent with certain disclosed embodiments;

FIG. 2 is a flow chart illustrating an exemplary process for determining price stabilization of extended services coverage consistent with certain disclosed embodiments; and

FIGS. 3a and 3b are graphs illustrating exemplary data used to determine values associated with extended services coverage consistent with certain disclosed embodiments.

### DETAILED DESCRIPTION

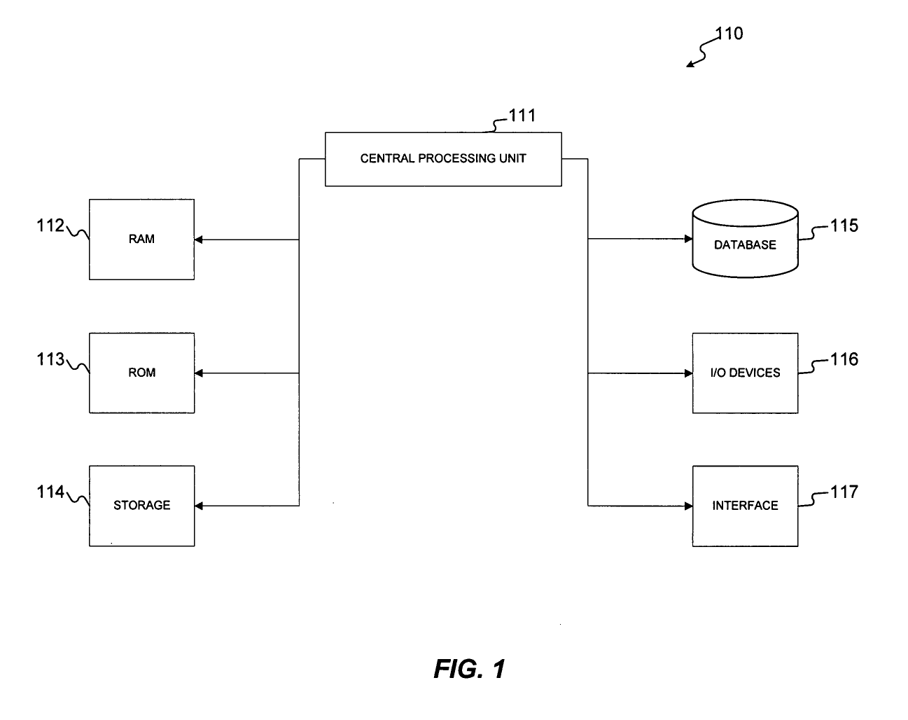

FIG. 1 illustrates an exemplary system 110 in which principles and methods consistent with the disclosed embodiments may be implemented. As shown in FIG. 1, system 110 may include one or more hardware and/or software components configured to collect, monitor, store, analyze, evaluate, distribute, report, process, record, and/or sort information associated with extended services coverage. For example, system 110 may include one or more hardware and/or software components such as, for example, a central processing unit (CPU) 111, a random access memory (RAM) module 112, a read-only memory (ROM) module 113, a storage 114, a database 115, one or more input/output (I/O) devices 116, and an interface 117. System 110 may be configured to collect, analyze, evaluate, report, and distribute information related to extended services coverage of one or more products. Non-limiting examples of products may include a mobile or non-mobile machine, an engine system, a pump/motor configuration, a power plant, a turbine, a machine system, and any components thereof. According to one embodiment, the product may be a machine system that includes an internal combustion engine for performing a task associated with an industry such as mining, construction, farming, transportation, power generation, or any other type of industry. It is contemplated that a product may include any suitable article that can be packaged with extended services coverage and sold to a customer as part of a product purchase transaction package, including either new or used products or any combination thereof. However, this is intended to be exemplary only and not limiting as the product and extended services coverage may be sold separately.

CPU 111 may include one or more processors, each configured to execute instructions and process data to perform functions associated with system 110. As illustrated in FIG. 1, CPU 111 may be communicatively coupled to RAM 112, ROM 113, storage 114, database 115, I/O devices 116, and interface 117. CPU 111 may be configured to execute computer program instructions to perform various processes and methods consistent with certain disclosed embodiments. The computer program instructions may be loaded into RAM 112 for execution by CPU 111.

RAM 112 and ROM 113 may each include one or more devices for storing information associated with an operation of system 110 and/or CPU 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of CPU 111. For example, instructions from ROM 113 may be loaded into RAM 112 for execution by CPU 111.

Storage 114 may include any type of mass storage device configured to store any type of information used by CPU 111 to perform one or more processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that store, organize, sort, filter, and/or arrange data used by system 110 and/or CPU 111. For example, database 115 may store historical information such as production costs, parts lists and costs, failure and trend data, labor costs, geographic modifiers, and the like, associated with a transaction of one or more products and/or types of products, or any other information that may be used by CPU 111 to determine an extended services coverage price associated with a product. Similarly, database 115 may store effective costs of ownership, internal extended services coverage data, and market extended services coverage data associated with each type of product, product line, or product family. It is contemplated that database 115 may store additional and/or different information than that listed above.

I/O devices 116 may include one or more components configured to communicate information with a user associated with system 110. For example, I/O devices may include a console with an integrated keyboard and mouse to allow a user to input parameters associated with system 110 or data associated with extended services coverage. I/O devices 116 may also include a display including a graphical user interface (GUI) for outputting information on a monitor. I/O devices 116 may also include peripheral devices such as, for example, a printer for printing information associated with system 110 or a user-accessible disk drive (e.g., a USB port, a floppy, CD-ROM, or DVD-ROM drive, etc.) to allow a user to input data stored on a portable media device. In addition, I/O devices 116 may also include a camera, a microphone, a speaker system, or any other suitable type of interface device.

Interface 117 may include one or more components configured to transmit and receive data via any appropriate communication network, such as, for example, the Internet, a local area network, a workstation peer-to-peer network, a direct link network, a wireless network, or any other suitable communication platform. In addition, interface 117 may include one or more modulators, demodulators, multiplexers, de-multiplexers, network communication devices, wireless devices, antennas, modems, and any other type of device configured to enable data communication via any suitable communication network. It is further anticipated that interface 117 may be configured to allow CPU 111, RAM 112, ROM 113, storage 114, database 115, and one or more input/output (I/O) devices 116 to be located remotely from one another and perform the method of collection, analysis, and distribution of data or other information.

System 110 may include additional, fewer, and/or different components than those listed above and it is understood that the listed components are exemplary only and not intended to be limiting. For example, it is contemplated that one or more of the hardware components listed above may be implemented using software such as, for example, storage 114 may include a software partition associated with one or more other hardware components of system 110. Alternatively and/or additionally, system 110 may include one or more software components such as, for example, a computer-readable medium including computer-executable instructions for performing the disclosed method.

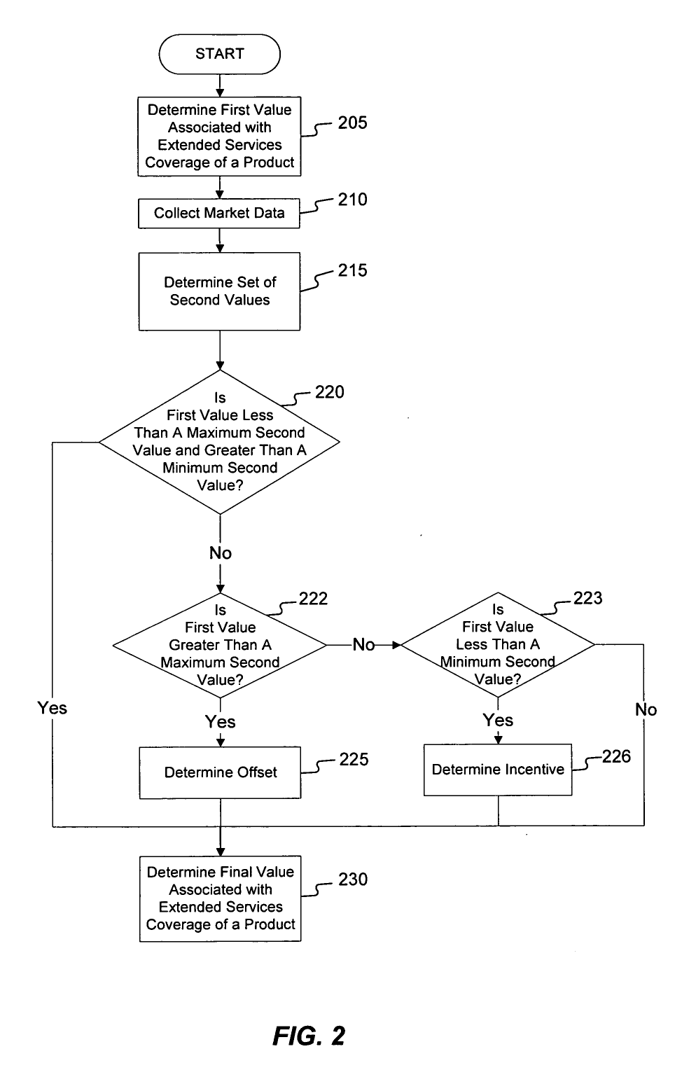

FIG. 2 illustrates a flowchart of an exemplary process for determining the price stabilization of extended services coverage consistent with certain disclosed embodiments. The process of FIG. 2 may be performed by system 110. For example, system 110 may execute one or more software programs that perform the process steps of FIG. 2. As shown in step 205, a first value associated with extended services coverage for a product may be determined. The first value may be, for example, a cost or price of the extended services coverage and may be a discrete value or a range of values. To determine the first value, quality and reliability data, including historical failure data, for a specified product may be collected, compiled, and analyzed. Labor rate information, economic trend information, and changes to the product as a result of any one or more of re-engineering, component changes, manufacturing changes, supplier changes, etc. may also be taken into account to determine the first value.

If no historical product data exists for the specified product to determine the first value, the quality and reliability data may be determined based on component data associated with one or more components of the specified product. The components may be individual components, groups of components, or assemblies of components. The quality and reliability data may be compiled and processed using, for example, actuarial processes known in the art to determine the first value for extended services coverage over a period of time. Other product characteristics that may be taken into account to determine a first value for the extended services coverage include, but are not limited to, a period of time (i.e., term) the extended services coverage is in effect, an event for which the extended services is in effect, hours of operation, type of services coverage (e.g., parts only, labor only, or parts and labor), one or more geographic regions, one or more countries of intended use, the type of application of the product, and other physical and/or functional characteristics particular to the product, such as components, sub-components, assemblages, and/or accessories. In addition, the extended services coverage may be broken down into one or more sub-terms. Sub-terms may be, for example, divisions of the entire term and may allow one or more product characteristics to vary and/or change over the term of extended services coverage for the product. This may be done, for example, by calculating and compiling the values for each sub-term over the entire term.

At step 210, system 110 may collect market data for extended services coverage of one or more similar or comparable products. A similar or comparable product may be a product that has similar functionality, structure, and/or purpose. In one embodiment, market data may be collected using any suitable method of systematically gathering data, such as surveys, questionnaires, interviews, and/or reviews of any publicly available materials including advertisements, databases, internet, and library resources. Market data may include, but is not limited to, cost and price values associated with extended services coverage for similar or comparable products, quality and reliability data for similar or comparable products, terms and conditions of comparable extended services coverage for similar or comparable products, etc. In addition, data associated with the specified product may also be collected including, for example, sale and profit data.

Based on the collected data, one or more second values or range of second values may be determined (step 215). In one embodiment, a maximum second value and a minimum second value may be determined and may define a range of second values. In one embodiment, the one or more second values may be a value related to a net cost to an entity (e.g., dealer, reseller, authorized service provider, etc.) for parts and/or labor covered by the extended services coverage.

The process of FIG. 2 may also include analyzing the first value against the one or more second values or range of second values (step 220). If the first value is less than a maximum second value and/or greater than a minimum second value, the first value may be determined to be the final value associated with the extended services coverage (step 230). If the first value is greater than a maximum second value (step 222, Yes), a portion of the first value may be offset to adjust the first value to be within the one or more second values or range of second values (step 225). Alternatively, if the first value is less than a minimum second value (step 223, Yes), the difference between the first value and the minimum second value may be used as an incentive (step 226). Non-limiting examples of offsets may include, for example, any one or more of a supplement, a buy down, a write off, a charge off, a price support, and the like. Non-limiting examples of incentives may include, for example, any one or more of a reward, a rebate, a refund, or the like. The value of the offset or incentive may be either the entire difference between the first value and a determined one or more second values or it may be a portion of the difference. In some embodiments, the value of the offset or incentive may be determined to be zero. Based on the determined value of the offset or incentive, a final value for the extended services coverage may be determined (step 230).

The process of FIG. 2 may be repeated periodically over time. In one exemplary embodiment, the process is repeated annually. However, the process may also be repeated biennially, semiannually, quarterly, monthly, weekly, daily, etc. Alternatively or additionally, it may be desirable to repeat one or more steps of the process. For example, steps 215-230 may be cyclically repeated until a satisfactory final value for the extended services coverage is achieved. A satisfactory final value may be defined by a user or computer-executed software process configured to identify extended services coverage values that meet certain criteria, such as defined acceptable values for a given product type, product component type, application of a given product, etc.

### INDUSTRIAL APPLICABILITY

The disclosed embodiments may be implemented with transactions involving extended services coverage. A transaction may be any type of business transaction, such as, for example, a sale, rental, lease, purchase, acquisition, or any other appropriate agreement for use of a particular product. The disclosed embodiments may achieve improved determination of values associated with extended services coverage, including price and cost, by reducing fluctuation in values associated with the extended services coverage. In particular, the disclosed embodiments may compensate for fluctuations in values of extended services coverage associated with a product through the use of offsets, incentives, and the like. The value may be a price or cost of the extended services coverage.

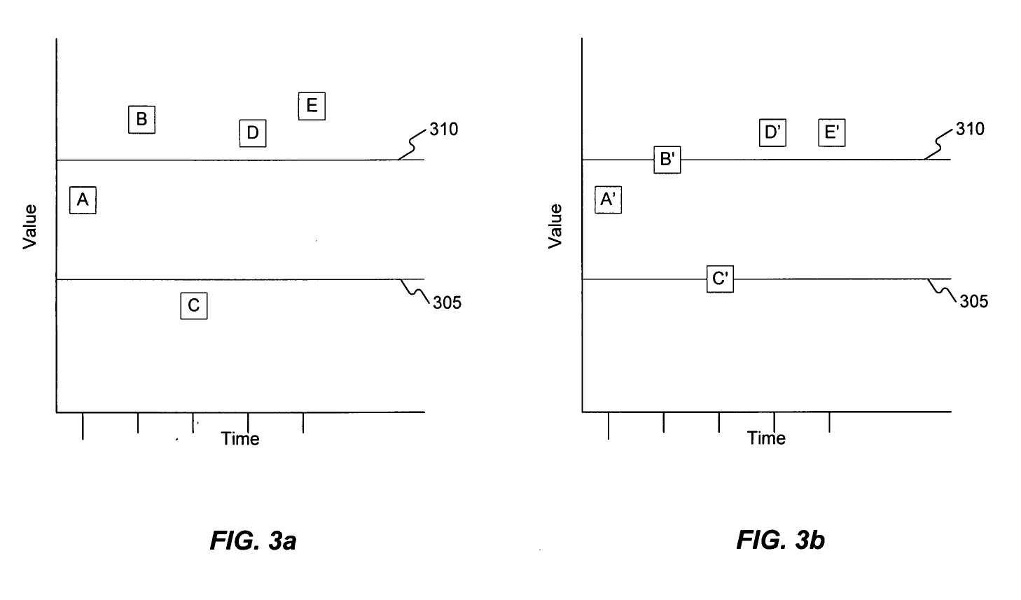

For example, FIGS. 3a and 3b show block diagrams exemplifying price stabilization of extended services coverage for a product over time. In the diagrams of FIGS. 3a and 3b, the x-axis represents time and the y-axis represents the value associated with extended services coverage for a given product. Line 310 may define a benchmark maximum value for extended services coverage while line 305 may define a benchmark minimum value for extended services coverage. The benchmark maximum value 310 and the benchmark minimum value 305 may be determined using processes similar to that described above in connection with step 215 of FIG. 2. In the exemplary embodiment, the benchmark maximum value 310 and benchmark minimum value 305 may be determined relative to a proportion of net cost to an entity (e.g., dealer, seller, reseller, or the like) associated with fulfillment of the extended services coverage. However, it is anticipated that the benchmark minimum value 305 and benchmark maximum value 310 may be any suitable value designed to serve as one or more points of reference. Further, while the exemplary embodiment discloses a benchmark maximum value 310 and a benchmark minimum value 305, the disclosed embodiment may use only one benchmark value for comparison with the first value as described above in step 220 of FIG. 2.

As discussed in step 205 of FIG. 2, the quality and reliability data for a product may be compiled and analyzed to determine a first value associated with extended services coverage for that product. In FIG. 3a, the first value is exemplified as reference point A. As shown in this example, first value A falls within a range defined by the benchmark maximum value 310 and the benchmark minimum value 305. Because first value A does not exceed the range defined by the benchmark minimum value 305 and the benchmark maximum value 310, it may remain unchanged and may be determined as the final value of the extended services coverage. This is exemplified as final value A in FIG. 3b. In one embodiment, the final value may be published and may become the market value for extended services coverage for the product. Publishing the final value may be done through any means by which information can be communicated including, for example, electronic means (e.g., internet, intranet, email, web pages, databases, etc.), print means (e.g., newspaper, letter, advertisement, mailings, catalogs, etc.), and/or through personal contact (e.g., phone call, meeting, verbal communication, etc.).

Referring again to FIG. 3a, reference point B defines a new first value associated with extended services coverage determined at a second point in time. In the exemplary embodiment, first value B exceeds the benchmark maximum value 310. Therefore, it may be determined that a portion of first value B may be offset. The offset may be in the form of a “buy down,” price support, or the like and may reduce the value of first value B such that the new value falls within the range defined by the benchmark maximum value 310 and the benchmark minimum value 305, as shown by reference point B′ in FIG. 3b. The value defined by reference point B′ may then be determined to be the final value of the extended services coverage, as discussed above in step 230 of FIG. 2.

Reference point C in FIG. 3a may define a first value associated with extended services coverage determined at a third point in time. In the exemplary embodiment, first value C is less than the benchmark minimum value 305. It may be determined that the value associated with the extended services coverage be raised to the benchmark minimum value 305, as shown by reference point C′ in FIG. 3b. The value defined by reference point C′ may then be determined to be the final value of the extended services coverage, as discussed in step 230 of FIG. 2. The difference between first value C and final value C′ may be distributed as a rebate, refund, or the like. Refunds, rebates, etc. may be distributed to other entities associated with other aspects related to the product (e.g., dealers, service agents, marketing, manufacturing, research and development, etc.). Alternatively, the value of C may only be partially raised to remain below the benchmark minimum value 305. As a result, the reduced difference between values C and C′ may reduce or eliminate the rebate, refund, or the like.

Reference point D in FIG. 3a defines a new first value of extended services coverage determined at a fourth point in time. Similarly to first value B, first value D exceeds the benchmark maximum value 310. However, the value of first value D may not be offset. Thus, the value of first value D may remain unchanged, as shown by reference point D in FIG. 3b. The value defined by reference point D may then be determined to be the final value of the extended services coverage, as discussed above in connection with step 230 of FIG. 2.

Reference point E in FIG. 3a may define a new first value of extended services coverage for a product determined at a fifth point in time. Similarly to first values B and D, the value of first value E exceeds the benchmark maximum value 310. However, it may be determined that only a portion of the value of first value E will be offset such that the offset will reduce the value of first value E but will not reduce it to within the range defined by the benchmark maximum value 310 and the benchmark minimum value 305. Thus, the value of first value E may be reduced to the value shown by reference point E′ in FIG. 3b. The value defined by reference point E′ may then be determined to be the final value of the extended services coverage, as discussed in step 230 of FIG. 2.

In some embodiments, the steps of determining a first value 205, collecting data 210, and determining one or more second values or range of second values 215 may be done by a first entity with or without a computer system, such as system 110. The first entity may be an individual or group and may be responsible for, either in whole or in part, coordinating collecting, analyzing, or distributing data associated with extended services coverage. The first entity may be, for example, a guarantor, warrantor, insurer, or the like. Also, in some embodiments, determining an offset or incentive may be done by one or more second entities. The one or more second entities may be individuals or groups and may be responsible for, either in whole or in part, generating, manufacturing, or otherwise creating a product. The one or more second entities may include a representative from one or more of, for example, a manufacturing group, an engineering group, a design group, a management group, etc. In some embodiments, determining a final value associated with extended services coverage may be done by either the first entity, the second entity, or any combination thereof.

Further, the disclosed embodiments may be performed by a user, or computer-executed software, or a combination thereof. For example, a user may determine a first value and may provide the value to system 110. In response, system 110 may perform one or more of the process steps described above in connection with FIG. 2.

To describe the features of the disclosed embodiments, consider an exemplary product, Machine_X, that may be associated with extended services coverage. Machine_X may be manufactured by Company_X and may be a new product for which no historical quality and reliability product data is available. Lacking historical product data, quality and reliability data for the components of Machine_X may be collected and analyzed by a warrantor to determine a first value. The warrantor may also consider a period of time for which the extended services coverage will be in effect (e.g., 6 months), a geographic region in which Machine_X will be used (e.g., South America), a country in which Machine_X will be used (e.g., Bolivia), a number of machine use hours for which the coverage is in effect (e.g., 1500), a type of coverage (e.g., parts and labor), etc. From this data, the warrantor may determine a price for extended services coverage of Machine_X. The warrantor may determine the estimated dealer net cost for providing parts and labor associated with the extended services coverage for Machine_X to be approximately $800. Thus, the benchmark minimum value and benchmark maximum value may be determined as a percent of dealer net cost such that the benchmark minimum is $880 (net cost+10%) and the benchmark maximum is $1,000 (net cost+25%).

The warrantor may also collect market data on Machine_Y, manufactured and sold by Company_Y, and Machine_Z, manufactured and sold by Company_Z. In this example, Machine_Y performs similar functionality and has a similar intended purpose as that of Machine_X. Machine_Z, in contrast, may have a similar intended purpose but may not be similar in functionality. Further, in this example, extended services coverage for Machine_Y may be $1,100 and extended services coverage for Machine_Z may range be $1,000. The value for extended services coverage for Machine_Y and Machine_Z may serve as points of comparison against which the business division or product group of Company_X responsible for Machine_X may evaluate the competitive value of Machine_X and its associated extended services coverage.

If, for example, the first value for the price of extended services coverage of Machine_X for 6 months of use in the South American country of Bolivia for up to 1500 hours of machine use with coverage for parts and labor is determined to be $800, then the warrantor may raise the final value of the extended services coverage to $900, the benchmark minimum value. The difference between the first value and the final value, $100, may be given as an incentive to the business division or product group responsible for Machine_X. However, if the first value for extended services coverage of machine X for 6 months of use in the South American country of Bolivia for up to 1500 hours of machine use with coverage for parts and labor is determined to be $1200. This exceeds the benchmark maximum value by $200. The final value may be determined to be the maximum benchmark value of $1,000 and the difference is offset through a charge off to the product group responsible for Machine_X. In this example, the final value is the price at which the extended services coverage is sold to the dealer. The dealer may, in turn, resell the extended services coverage at the same price or may resell the extended services coverage at a higher or lower price.

It will be apparent to those skilled in the art that various modifications and variations can be made in the price stabilization method. It is intended that the specification and examples be considered as exemplary only, with a true scope of the disclosed embodiments being indicated by the following claims and their equivalents.

What is claimed is:

1. A method for providing price stabilization for extended services coverage of a product, comprising:
determining a first value associated with an extended services coverage of a first product;
determining a set of second values associated with the first product, the set of second values reflecting values associated with the extended services coverage;
determining a third value based on the first value and the set of second values to determine whether the first value is within a range defined by the set of second values;
determining a final value for the extended services coverage of the first product based on the first value and the third value; and
providing the final value to an entity for use in a transaction package involving the extended services coverage for the first product.

2. The method as in claim 1, wherein the set of second values associated with the first product is determined by collecting data associated with one or more second products.

3. The method as in claim 1, wherein the set of second values includes one or more of a minimum value or a maximum value.

4. The method as in claim 1, wherein determining the final value includes determining a difference between the first value and the third value.

5. The method as in claim 1, wherein determining the final value includes determining the final value as a combination of the first value and the third value.

6. The method as in claim 1, wherein the third value reflects one or more of a supplement, a buy down, a write off, or a price support associated with the extended services coverage for the product.

7. The method as in claim 1, wherein the third value reflects one or more of a rebate or a refund associated with the extended services coverage for the product.

8. The method as in claim 1, wherein the final value reflects a cost of the extended services coverage for the product.

9. The method as in claim 1, wherein the final value reflects a price for the extended services coverage of a product.

10. A system for providing price stabilization for extended services coverage of a product, comprising:
a memory including program code for providing price stabilization for extended services coverage; and
a processor configured to execute the program code to determine a first value associated with an extended services coverage of a first product, determine a set of second values associated with the product, the set of second values reflecting values associated with the extended services coverage, determine a third value based on the first value and the set of second values, determine a final value for extended services coverage of the product based on the first value and the third value, and provide the final value to an entity for use in a transaction package involving the extended services coverage for the first product.

11. The system of claim 10, wherein the set of second values associated with the first product is determined by collecting data associated with one or more second products.

12. The system of claim 10, wherein the set of second values includes one or more of a minimum value or a maximum value.

13. The system of claim 10, wherein the processor is configured to determine the final value reflecting a difference between the first value and the third value.

14. The system of claim 10, wherein the processor is configured to determine the final value reflecting a combination of the first value and the third value.

15. The system of claim 10, wherein the third value reflects one or more of a supplement, a buy down, a write off, or a price support associated with the extended services coverage for the product.

16. The system of claim 10, wherein the third value reflects one or more of a rebate or a refund associated with the extended services coverage for the product.

17. The system of claim 10, wherein the final value reflects a cost of the extended services coverage for the product.

18. The system of claim 10, wherein the final value reflects a price for the extended services coverage for the product.

19. A method for providing price stabilization for extended services coverage of a product, comprising:
determining whether a first value for an extended services coverage for a first product is within a determined range of second values;
if the first value exceeds the range of second values:
determine an offset value,
apply the offset value to the first value to determine a final value,
if the first value is below the range of second values:
determine an incentive value,
apply the incentive to the first value to determine a final value; and
provide the final value to an entity for use in a transaction package involving the extended services coverage and the first product.

20. The method as in claim 19, wherein the final value reflects one of a cost or a price for extended services coverage for the first product.
